(19) United States
(12) Patent Application Publication
(10) Pub. No.: US 2007/0115351 A1
(43) Pub. Date: May 24, 2007

(54) Methods and systems for enhanced motion detection

(76) Inventor: Kenneth McCormack, Albany, OR (US)

Correspondence Address: PATRICK W. RASCHE (22697);ARMSTRONG TEASDALE LLP, ONE METROPOLITAN SQUARE, SUITE 2600, ST. LOUIS, MO, 63102-2740, US

(21) Appl. No.: 11/282,325

(22) Filed: Nov. 18, 2005

(51) Int. Cl. H04N 7/00; H04N 7/18

(52) U.S. Cl. 348/36; 348/143

(57) ABSTRACT

Methods and apparatus for a video surveillance system are provided. The system includes a pan/tilt/zoom video camera assembly and a processor configured to control the pan/tilt/zoom video camera assembly to generate a panoramic reference image of a selectable motion detection area, acquire images of the motion detection area, and determine a motion in the motion detection area using a comparison of the acquired images of the motion detection area and the panoramic reference image.

### BACKGROUND OF THE INVENTION

This invention relates generally to video surveillance systems and, more particularly, to video surveillance systems with enhanced motion detection.

At least some known video surveillance systems include one or more video cameras mounted in a housing along with a pan, tilt, and zoom (PTZ) assembly. The PTZ permits controlling a movement of the camera to align a viewing area of the camera with an object of interest or location of interest. The zoom portion of the mechanism may be used to adjust a field of view of the camera. The housing protects the camera from the environment in the location where the camera and PTZ assembly are mounted.

The speed at which an area larger than the field of view of the camera can be viewed is limited by the visual perception of the operator. If the camera motion is too fast the operator cannot distinguish items and quickly losses attention. Some known motion detection is performed by fixed cameras. The cameras store one still image as the reference and continuously compare new images with this reference. In PTZ cameras the camera can move to cover a surveillance area larger than the camera field of view and the reference image needs to be correlated to the current view of the camera.

### BRIEF DESCRIPTION OF THE INVENTION

In one embodiment, a video surveillance system includes a pan/tilt/zoom video camera assembly and a processor configured to control the pan/tilt/zoom video camera assembly to generate a panoramic reference image of a selectable motion detection area, acquire images of the motion detection area, and determine a motion in the motion detection area using a comparison of the acquired images of the motion detection area and the panoramic reference image.

In another embodiment, a pan/tilt/zoom video camera assembly includes a video camera, a pan/tilt assembly configured to rotate said video camera about a substantially vertical pan axis and a substantially horizontal tilt axis, and a processor configured to control said pan/tilt assembly and said video camera assembly to generate a panoramic reference image of a selectable motion detection area, acquire images of the motion detection area, and determine a motion in the motion detection area using a comparison of the acquired images of the motion detection area and the panoramic reference image.

In yet another embodiment, a method of operating a pan/tilt/zoom video camera assembly includes generating a panoramic reference image of a selectable motion detection area, acquiring images of the motion detection area, and determining a motion in the motion detection area using a comparison of the acquired images of the motion detection area and the panoramic reference image.

### BRIEF DESCRIPTION OF THE DRAWINGS

FIG. 1 is a schematic view of an exemplary video surveillance system in accordance with an embodiment of the present invention;

FIG. 2 is a schematic diagram of an exemplary embodiment of pan/tilt/zoom video camera assembly shown in FIG. 1; and

FIG. 3 is a flowchart of an exemplary method of operating the pan/tilt/zoom video camera assembly for enhanced motion detection.

### DETAILED DESCRIPTION OF THE INVENTION

As used herein, an element or step recited in the singular and proceeded with the word “a” or “an” should be understood as not excluding plural elements or steps, unless such exclusion is explicitly recited. Furthermore, references to “one embodiment” of the present invention are not intended to be interpreted as excluding the existence of additional embodiments that also incorporate the recited features.

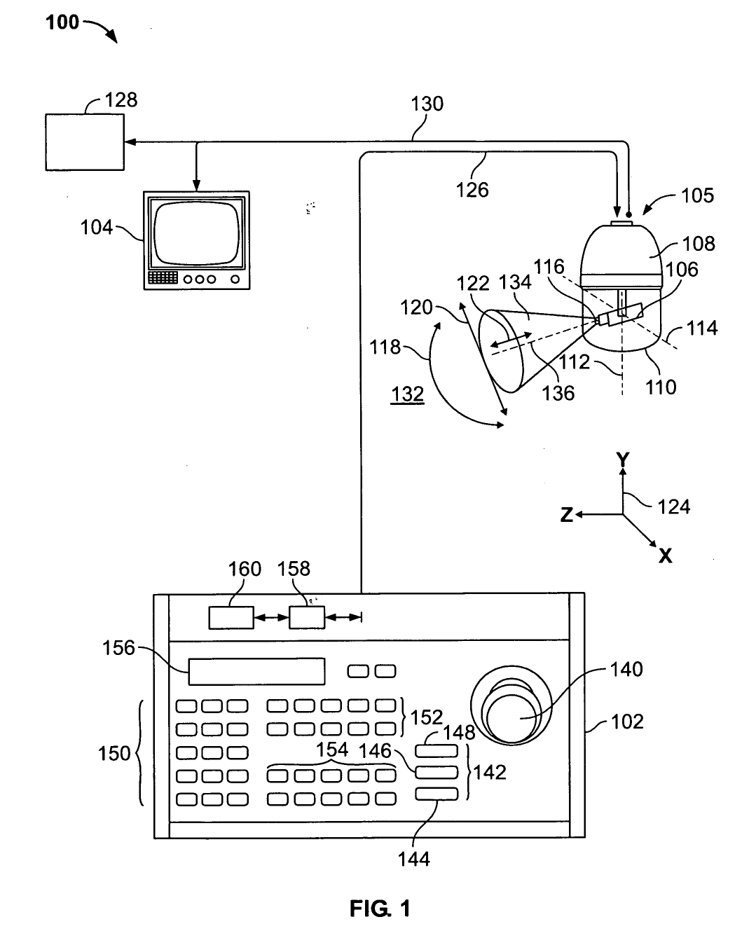

FIG. 1 is a schematic view of an exemplary video surveillance system 100 in accordance with an embodiment of the present invention. Video surveillance system 100 includes a control panel 102, a display monitor 104, and a pan/tilt/zoom video camera assembly 105. Typically, a camera 106 is housed in an enclosure 108 having a dome 110 for protecting camera 106 from the environment where camera 106 is located. In one embodiment, dome 110 is tinted to allow camera 106 to acquire images of the environment outside of enclosure 108 and simultaneously prevent individuals in the environment being observed by camera 106 from determining the orientation of camera 106. In various alternative embodiments, dome 110 is not tinted. In the exemplary embodiment, camera 106 includes capabilities to pan about a vertical axis 112, tilt about a horizontal axis 114, and control a lens assembly 116 to cause camera 106 to zoom. For example, pan/tilt/zoom video camera assembly 105 includes a pan motor and encoder (not shown) and tilt motor and encoder (not shown). The encoders determine an angular position of the pan and tilt motor and generate position signals that are used with a zoom setting to determine an area in the field of view. Panning movement of camera 106 is represented by an arrow 118, tilting movement of camera 106 is represented by arrow 120 and the changing of the focal length of lens assembly 116 of camera 106, i.e., zooming, is represented by arrow 122. As shown with reference to a coordinate system 124, panning motion may track movement along the x-axis, titling motion may track movement along the y-axis and focal length adjustment may be used to track movement along the z-axis. Signals representing commands to control such capabilities are transmitted from control panel 102 through a control data line 126. Image data signals are transmitted from camera 106 to display monitor 104 and a storage device 128 through a video data line 130.

Lens assembly 116 views an area of a location 132, which may be remote from control panel 102 and is in a field of view 134 and along a viewing axis 136 of lens assembly 116. Images of location 132 are converted by camera 106 into an electrical video signal, which is transmitted to display monitor 104.

In the exemplary embodiment, control panel 102 includes an X-Y control joystick 140 that is used to generate pan and tilt commands. A plurality of rocker-type switches 142 are used to control a zoom 144, a focus 146, and an iris 148 of lens assembly 116. In an alternative embodiment, joystick 140 includes a twist actuation that is used to control the zoom of camera 106. Joystick 140 may also incorporate triggers and/or buttons to facilitate operating various controls associated with system 100. Control panel 102 also includes a numeric keypad 150 for entering numbers and values. In an alternative embodiment, control panel 102 may include an alpha or alphanumeric keypad (not shown) for entering text as well as numbers. Control panel 102 further includes a plurality of preset switches 152 that may be programmed to execute macros that automatically control the actions of camera 106 and/or lens assembly 116. A plurality of buttons 154 may be used, for example, for predetermined control functions and/or user-defined functions, for example, a camera selection in a multi-camera video surveillance system. A display 156 may be used to display a status of video surveillance system 100 or may be used to display parameters associated with a selected camera.

A processor 158 receives programmed instructions, from software, firmware, and data from memory 160 and performs various operations using the data and instructions. Processor 158 may include an arithmetic logic unit (ALU) that performs arithmetic and logical operations and a control unit that extracts instructions from memory 160 and decodes and executes them, calling on the ALU when necessary. Memory 160 generally includes a random-access memory (RAM) and a read-only memory (ROM), however, there may be other types of memory such as programmable read-only memory (PROM), erasable programmable read-only memory (EPROM) and electrically erasable programmable read-only memory (EEPROM). In addition, memory 160 may include an operating system, which executes on processor 158. The operating system performs basic tasks that include recognizing input, sending output to output devices, keeping track of files and directories and controlling various peripheral devices.

The term processor, as used herein, refers to central processing units, microprocessors, microcontrollers, reduced instruction set circuits (RISC), application specific integrated circuits (ASIC), logic circuits, and any other circuit or processor capable of executing the functions described herein. Memory 160 may include storage locations for the preset macro instructions that may be accessible using one of the plurality of preset switches 142.

As used herein, the terms “software” and “firmware” are interchangeable, and include any computer program stored in memory for execution by processor 158, including RAM memory, ROM memory, EPROM memory, EEPROM memory, and non-volatile RAM (NVRAM) memory. The above memory types are exemplary only, and are thus not limiting as to the types of memory usable for storage of a computer program.

In various embodiments, processor 158 and memory 160 are located external to camera 106 such as in control panel 102 or in a PC or other standalone or mainframe computer system capable of performing the functions described herein.

In the exemplary embodiment, video surveillance system 100 is a single camera application, however, various embodiments of the present invention may be used within a larger surveillance system having additional cameras which may be either stationary or moveable cameras or some combination thereof to provide coverage of a larger or more complex surveillance area. In an alternative embodiment, one or more video recorders (not shown) are connected to control panel 102 to provide for recording of video images captured by camera 106 and other cameras in system 100.

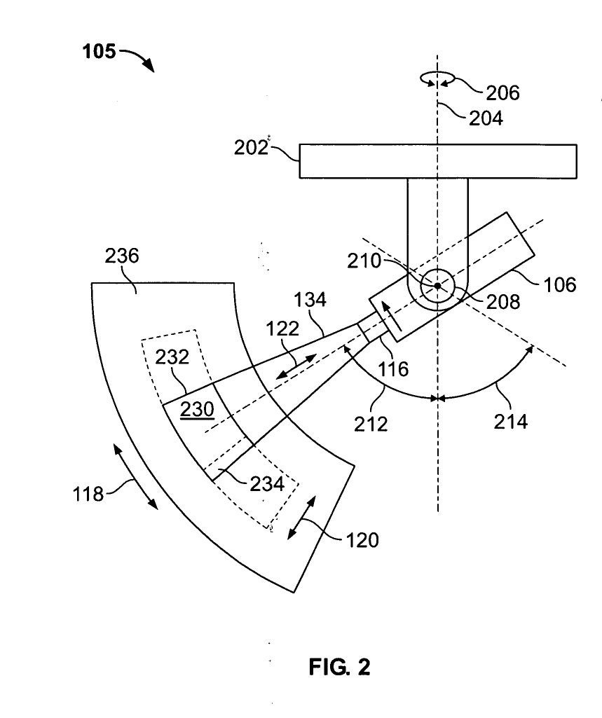

FIG. 2 is a schematic diagram of an exemplary embodiment of pan/tilt/zoom video camera assembly 105 (shown in FIG. 1). Pan/tilt/zoom video camera assembly 105 includes a camera 106, a pan mechanism 202 that is configured to rotate the video camera about a pan axis 204 in a clockwise and a counter clockwise pan direction 206. In the exemplary embodiment, pan mechanism 202 is configured to pan continuously about pan axis 204. In an alternative embodiment, pan mechanism 202 is configured to pan less than a full rotation about pan axis 204. Pan/tilt/zoom video camera assembly 105 also includes a tilt mechanism 208 coupled to the pan mechanism and configured to rotate video camera 106 about a tilt axis 210 (illustrated normal to the figure). In the exemplary embodiment, tilt mechanism 208 is configured to rotate camera 106 about tilt axis 210 greater than ninety degrees through an angle 212 and an angle 214 with respect to pan axis 204. In such embodiment, the total tilt of camera 106 is greater than one hundred eighty degrees. A controller, such as control panel 102, is communicatively coupled to pan mechanism 202 and tilt mechanism 208. Controller 102 is configured to receive a first image of a view acquired from a first address wherein the address indicates a pan rotation angle with respect to an index, such as an initial starting or “parked” position. The address also indicates a tilt angle with respect to pan axis 204, and a zoom setting of lens assembly 116. In the exemplary embodiment, when camera 106 is rotated about tilt axis 210 through zero degrees with respect to pan axis 204, for example camera 106 is oriented pointing vertically downward, the video image is electronically flipped, such that the image, as perceived by the user, is oriented right side up.

In the exemplary embodiment, a view 230 is the area within the field of view of camera 106 at a particular address, for example, at a pan angle, tilt angle, and zoom setting. An image is acquired of view 230 by camera 106. The image may be stored, displayed, processed for enhancement, and/or combined with other images. In the exemplary embodiment, images of adjacent views are registered with respect to objects within each image and combined to form a larger panoramic image of multiple views. The images may be registered edge to edge 232 or may include an area of overlap 234 to facilitate registering the images. In the exemplary embodiment, a panoramic motion detection area 236 includes a plurality of views 230 contiguously oriented about a field of view of camera 106. In an alternative embodiment, views 230 are not contiguously oriented.

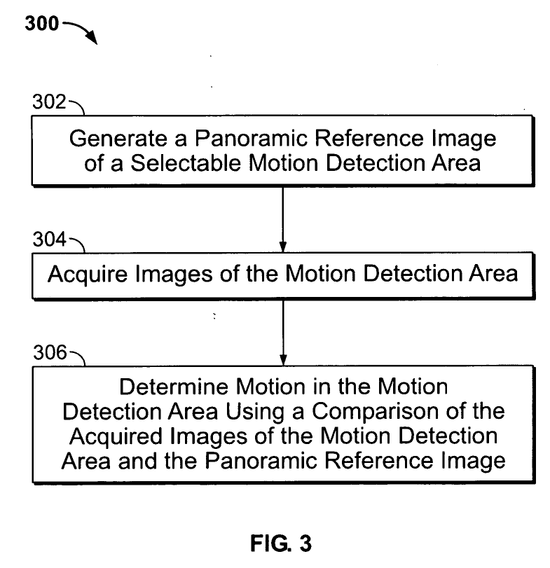

FIG. 3 is a flowchart of an exemplary method 300 of operating a pan/tilt/zoom video camera assembly for enhanced motion detection. A motion detection algorithm is described wherein the area of motion detection to be covered is larger than any single camera field of view. The algorithm records a plurality of images of the motion detection area that are addressed as a single panoramic image. The camera is then moved in any direction. While in a motion detection mode, the video from camera is correlated with the pre-stored panoramic reference image. The images of the views acquired during a scan are compared to a corresponding location in the panoramic reference image. If the comparison determines the acquired images do not match the reference image, then motion is indicated and a motion detected event is triggered.

Method 300 includes generating 302 a panoramic reference image of a selectable motion detection area. In the exemplary embodiment, a user designates an area within the range of view of the pan/tilt/zoom video camera as a motion detection area by “painting the screen” while moving the pan/tilt/zoom video camera. Any area covered by the paint will be within the selected motion detection area. The painting is done similar to the privacy masks on some known cameras. In this instance, the paint is a transparent color however, thus allowing the user to see through the paint. The area painted is not limited to rectangular shapes.

During operation, the user initiates the motion detection mode. The camera will use the motion detection area defined in step 302 as the area to quickly obtain a record of as a single image. Multiple are images acquired 304 during a scan of the motion detection area and are registered into a panoramic reference image. The reference image is associated with the camera position and zoom where each image was acquired.

After entering the motion detection mode, the pan/tilt/zoom video camera automatically generates a scan that best fits the motion detection area selected above. The user does not need to specify the scan path precisely. The path is based on a constraint mapping of the camera motion to the area with the time duration of the scan as a minimizing factor. The camera is commanded to move substantially faster than in normal user observation operation permitting the motion detection area to be scanned faster than during normal user observation. In the exemplary embodiment, the scan time exceeds three times faster than during normal user observation. Additionally, the motion of the camera is randomized to facilitate reducing the possibility of targets defeating the surveillance by observing pan/tilt/zoom video camera motion. Areas outside the detect area are ignored. During motion detection mode, the rate of panning and tilting of the pan/tilt/zoom video camera precludes meaningful observation by the user, so a current still image of the scan is output to the display with a selectable periodicity and duration, for example, every one second to facilitate monitoring the motion detection area as well as giving reasonable indication that the system is operating satisfactorily.

During the time in this mode, received images from the pan/tilt/zoom video camera are compared to the reference image. In the exemplary embodiment, differences above a threshold stop the motion detect mode and the user is alerted that motion has been detected 306. A programmed target tracking algorithm may also be initiated such that the cause of the motion detected is followed throughout the viewing area of the pan/tilt/zoom video camera and information about the target transmitted to other pan/tilt/zoom video cameras in the surveillance system such that there can be a handoff of tracking to a next pan/tilt/zoom video camera if the target moves into the next camera viewing area.

The above described surveillance method controls the video camera to move at a speed substantially faster than typical visual scanning speeds. The faster scanning speed permits a larger viewing area to be monitored in a shorter time thus facilitating reducing the probability of missing events. In the exemplary embodiment, the surveillance system alerts the operator only if the area under surveillance changes.

The above-described embodiments of a video surveillance system provide a cost-effective and reliable means for automating many of the surveillance operations of a security camera comparing current images during a motion detect scan to a panoramic reference image permits the surveillance system to cover a larger area in a shorter time span.

Exemplary embodiments of video surveillance systems and apparatus are described above in detail. The video surveillance system components illustrated are not limited to the specific embodiments described herein, but rather, components of each system may be utilized independently and separately from other components described herein. For example, the video surveillance system components described above may also be used in combination with different video surveillance system components. A technical effect of the various embodiments of the systems and methods described herein include facilitating operation and maintenance of video surveillance system by permitting relatively fast scanning of a viewing area larger than the field of view of the camera.

While the invention has been described in terms of various specific embodiments, those skilled in the art will recognize that the invention can be practiced with modification within the spirit and scope of the claims.

What is claimed is:

1. A video surveillance system comprising:
a pan/tilt/zoom video camera assembly; and
a processor configured to control the pan/tilt/zoom video camera assembly to:
generate a panoramic reference image of a selectable motion detection area;
acquire images of the motion detection area;
mask out user defined areas where motion detection is not required; and
determine a motion in the motion detection area using a comparison of the acquired images of the motion detection area and the panoramic reference image.

2. A system in accordance with claim 1 wherein said processor is further configured to:
acquire images of a plurality of respective adjacent views of a motion detection area;
combine the images to form a panoramic image of the motion detection area; and
determine which portions of the panoramic image are to be included in motion detection calculations.

3. A system in accordance with claim 1 wherein said processor is further configured to at least one of pan, tilt, and zoom the pan/tilt/zoom video camera assembly to select the motion detection area.

4. A system in accordance with claim 1 wherein said processor is further configured to register images of a plurality of respective adjacent views of the motion detection area edge to edge.

5. A system in accordance with claim 1 wherein said processor is further configured to register images of a plurality of respective adjacent views of the motion detection area using portions of each image that overlap.

6. A system in accordance with claim 1 wherein said processor is further configured to associate each view of the reference image to an address.

7. A system in accordance with claim 1 wherein said processor is further configured to at least one of pan, tilt, and zoom the pan/tilt/zoom video camera assembly automatically along a selectable scan path.

8. A system in accordance with claim 1 wherein said processor is further configured to compare the image acquired at an address associated with the image to the view of the reference image at substantially the same address.

9. A pan/tilt/zoom video camera assembly comprising:
a video camera;
a pan/tilt assembly configured to rotate said video camera about a substantially vertical pan axis and a substantially horizontal tilt axis; and
a processor configured to control said pan/tilt assembly and said video camera assembly to:
generate a panoramic reference image of a selectable motion detection area;
acquire images of the motion detection area; and
determine a motion in the motion detection area using a comparison of the acquired images of the motion detection area and the panoramic reference image.

10. A method of operating a pan/tilt/zoom video camera assembly comprising:
generating a panoramic reference image of a selectable motion detection area;
acquiring images of the motion detection area; and
determining a motion in the motion detection area using a comparison of the acquired images of the motion detection area and the panoramic reference image.

11. A method in accordance with claim 10 wherein generating a panoramic reference image comprises:
acquiring images of a plurality of respective adjacent views of a motion detection area; and
combining the images to form a panoramic image of the motion detection area.

12. A method in accordance with claim 10 wherein generating a panoramic reference image comprises at least one of panning, tilting, and zooming to select the motion detection area.

13. A method in accordance with claim 10 wherein generating a panoramic reference image comprises registering images of a plurality of respective adjacent views of the motion detection area edge to edge.

14. A method in accordance with claim 10 wherein generating a panoramic reference image comprises associating each view of the reference image to an address.

15. A method in accordance with claim 10 wherein panning, tilting, and zooming to acquire images for use by a user is limited by the user's visual perception to a first speed and wherein acquiring images of the motion detection area comprises panning, tilting, and zooming at a speed greater than the first speed.

16. A method in accordance with claim 15 wherein panning, tilting, and zooming at a speed greater than the first speed comprises panning, tilting, and zooming at a speed approximately ten times greater than the first speed.

17. A method in accordance with claim 10 wherein acquiring images of the motion detection area comprises automatically panning, tilting, and zooming the pan/tilt/zoom video camera assembly along a selectable scan path.

18. A method in accordance with claim 17 wherein automatically panning, tilting, and zooming the pan/tilt/zoom video camera assembly comprises automatically panning, tilting, and zooming the pan/tilt/zoom video camera assembly along a random scan path.

19. A method in accordance with claim 17 wherein automatically panning, tilting, and zooming the pan/tilt/zoom video camera assembly comprises automatically panning, tilting, and zooming the pan/tilt/zoom video camera assembly such that the scan path is selectable to be the shortest time duration scan path from the available scan paths.

20. A method in accordance with claim 10 wherein determining a motion in the motion detection area comprises comparing the image acquired at an address associated with the image to the view of the reference image at substantially the same address.
